(19) United States
(12) Patent Application Publication
(10) Pub. No.: US 2017/0247502 A1
(43) Pub. Date: Aug. 31, 2017

(54) Curable Epoxy Composition Including Accelerator

(71) Applicant: Dow Global Technologies LLC, Midland, MI (US)

(72) Inventors: Huifeng Qian, Pearland, TX (US); Gary A. Hunter, Lake Jackson, TX (US); Gyongyi Gulyas, Lake Jackson, TX (US)

(21) Appl. No.: 15/504,673

(22) PCT Filed: Nov. 18, 2015
(86) PCT No.: PCT/US2015/061253

§ 371 Date: Feb. 17, 2017

Related U.S. Application Data
(60) Provisional application No. 62/082,180, filed on Nov. 20, 2014.
(60) Provisional application No. 62/248,362, filed on Oct. 30, 2015.

(51) Int. Cl. C08G 59/68; C08G 59/50; B29C 70/48; C08J 5/04; B29C 70/52; C08G 59/38; C08G 59/72

(52) U.S. Cl. CPC C08G 59/685; C08G 59/38; C08G 59/5033; C08G 59/5026; C08G 59/72; C08J 5/04; B29C 70/52; B29C 70/48; C08J 2363/04; B29K 2063/00

(57) ABSTRACT

A curable composition includes an epoxy resin component that includes at least one multifunctional epoxy novolac resin and at least one multifunctional liquid epoxy resin, an amine hardener component that includes at least one aromatic amine and optionally at least one cycloaliphatic amine, and an accelerator component that includes (i) at least one transition metal complex having a transition metal ion and an oxygen donor ligand, and (ii) at least one salt having a cation including a metal ion or an onium ion, and an anion including a non-nucleophilic anion.

### FIELD

Embodiments relate to epoxy resin compositions that include accelerator compositions for fast curing, the use of such epoxy resin compositions, the method of manufacturing such epoxy resin compositions, and the method of manufacturing composite articles using such epoxy resin compositions.

### INTRODUCTION

An exemplary method of manufacturing composite articles includes a Pultrusion-Resin Transfer Molding (PRTM) process, which is a combination of a pultrusion process and a resin transfer molding (RTM) process. An exemplary PRTM process is discussed in U.S. Pat. No. 7,867,568. The PRTM process is an economical process that can produce high performance structural profiles and/or relatively high production speeds. Improved formulations for use in manufacturing composition articles, e.g., in PRTM processes, pultrusion processes, RTM processes, and/or filament winding processes, are sought.

### SUMMARY

Embodiments may be realized by providing a curable composition that includes an epoxy resin component that includes at least one multifunctional epoxy novolac resin and at least one multifunctional liquid epoxy resin, an amine hardener component that includes at least one aromatic amine and optionally at least one cycloaliphatic amine, and an accelerator component that includes (i) at least one transition metal complex having a transition metal ion and an oxygen donor ligand, and (ii) at least one salt having a cation including a metal ion or an onium ion, and an anion including a non-nucleophilic anion.

### BRIEF DESCRIPTION OF THE DRAWINGS

FIG. 1 illustrates an exemplary pultrusion-resin transfer molding (PRTM) process.

FIG. 2 illustrates a graphical representation of the exotherm peak for an epoxy based composition prepared with various accelerator components, according to exemplary embodiments and comparative examples.

FIG. 3 illustrates a graphical representation of glass transition temperature versus various stoichiometric ratios, according to exemplary embodiments.

FIG. 4 illustrates a graphical representation of the dynamic mechanical thermal analysis (DMTA) when using an accelerator component according to exemplary embodiments.

FIGS. 5 and 6 illustrate graphical representations of the exotherm peaks when using accelerator components according to exemplary embodiments, as measured by DSC.

### DETAILED DESCRIPTION

Certain composition manufacturing processes, and equipment used therein, have specific requirements for resin systems. For example, to meet the manufacturing requirement of Pultrusion-Resin Transfer Molding (PRTM) process, a complex rheology behavior is sought for curable composition used therein. Desirable properties for the curable composition include the following: (1) a viscosity at room temperature of higher than 4,000 mPa*s to reduce the possibility of and/or avoid leakage of the resin from an injection mold inlet (at the front end of the die); (2) a low viscosity (e.g., from 10 mPa*s to 500 mPa*s) at the higher temperature (such as greater than 50° C.) of point of injection to allow for good impregnation of a reinforcement package; (3) a controllable curing speed to form a partially cured “B” stage part in curing die, typically at relatively lower temperature; (4) a fast cure in a higher temperature heated press (RTM stage), while minimizing resin flow; and/or (5) a minimized use of post-cure oven to lower the overall cost of manufacturing the part.

Accordingly, embodiments related to providing an epoxy resin component, an amine hardener component, and an accelerator component that can provide the desired viscosity, a slow cure within a first temperature range, and a fast cure within a second temperature range (e.g., that does not overlap the first temperature range) between an epoxy resin and an amine hardener, while still retaining a balance of good performance properties (such as glass transition temperature) and good mechanical properties (such as tensile strength). For example, embodiments relate to a combination of an epoxy resin component, an amine hardener component, and an accelerator component that has latency (relatively slow cure) at ambient temperature conditions or slightly elevated temp conditions and an acceleration (relatively fast cure) effect at more elevated temperature conditions. In exemplary embodiments, the accelerator component includes at least a transition metal complex having a transition metal (such as chromium (III), zinc (II), and/or Mo (III)) and an oxygen donor ligand (such as an octoate or acetyl acetonate) and a salt having a cation including a metal ion or an onium ion and an anion including a non-nucleophilic anion. When an exemplary PRTM process is used for a method of a manufacturing a composite article, the latency within a specific temperature range, may allow for time for the composition to travel to a pultrusion die.

### Terms

As used herein, “fast cure”, means a curing reaction of the epoxide with the hardeners can be conducted within a short time (e.g., from a few minutes to less than about 60 minutes), e.g., at cure temperatures from 40° C. to 160° C. A significant accelerating effect on the reactivity of an epoxy-aromatic amine composition refers to significantly lowering the temperature or time for curing a reaction of epoxide with hardeners.

“Slow cure” means a hardener shows very low or limited reactivity with an epoxy.

“Latency” means a hardener that shows very low or limited reactivity with an epoxy at temperatures near room temperature (e.g., from 18° C. to 30° C.), but yet the hardener reacts with an epoxy at a fast rate at elevated temperatures. For example, if the gel time at 25° C. is about 40 hours, and the gel time at 150° C. is only 59 seconds, the composition shows good latency.

“Gel time” means the mixture is substantially incapable of flow and in molecular terms gel time refers to the point at which an infinite network is formed. For example, based on the latency properties, the curable composition may have a gel time at room temperature of at least 30 minutes (e.g., and up to 300 minutes). The gel time at elevated temperatures (e.g., 80° C. to 200° C.) may be less than 30 minutes (e.g., less than 1 minute).

“Pot life” means the amount of time it takes for an initial viscosity of a composition to double, or quadruple for low viscosity (e.g., <1000 mPa-s) products. Timing starts from the moment the components of the composition are mixed, and the viscosity is measured at room temperature. A “long pot life”, means the viscosity of the formulation, including an epoxy resin component, a hardener component, and an accelerator component increases slowly.

The viscosity of a fluid is a measure of the fluid's resistance to gradual deformation by shear stress or tensile stress. “Low viscosity” means that the viscosity is, e.g., low enough to provide rapid impregnation of a reinforcement package. For example, the viscosity may be less than 500 mPa*s at the point of injection.

“Excellent performance properties” means a good glass transition temperature and/or the like. For example, a glass transition temperature greater than 140° C., at dry conditions.

“Excellent mechanical properties” means high tensile strength, tensile modulus, tensile strain, fracture toughness, and/or the like. For example, the tensile strength may be greater than 60 MPa, a tensile modulus may be greater than 2500 MPa, and/or a percent elongation at break may be greater than 3.5%.

### Epoxy Resin Component

The epoxy resin component includes at least one liquid epoxy resin and at least one epoxy novolac resin. The liquid epoxy resin and the epoxy novolac resins are multifunctional epoxy resins. By multifunctional it is meant the epoxy resin has on average more than one unreacted epoxide unit per molecule. The epoxy resin component may account for 55 wt % to 95 wt % (e.g., 60 wt % to 90 wt %, 65 wt % to 85 wt %, 65 wt % to 80 wt %, 65 wt % to 75 wt %, etc.) of a curable composition. For example, when the curable composition includes the epoxy resin component, the amine hardener component, and the accelerator component.

The epoxy resin component may include the at least one epoxy novolac resin in an amount from 5 wt % to 95 wt % (e.g., 5 wt % to 90 wt %, 5 wt % to 80 wt %, 5 wt % to 70 wt %, 5 wt % to 60 wt %, 5 wt % to 50 wt %, 10 wt % to 40 wt %, 10 wt % to 30 wt %, 15 wt % to 25 wt %, etc.), based on the total weight of the epoxy resin component. The epoxy resin component may include the at least one liquid epoxy resin in an amount from 5 wt % to 95 wt % (e.g., 10 wt % to 95 wt %, 20 wt % to 95 wt %, 30 wt % to 95 wt %, 40 wt % to 95 wt %, 50 wt % to 95 wt %, 50 wt % to 90 wt %, 60 wt % to 90 wt %, 70 wt % to 90 wt %, 75 wt % to 85 wt %, etc.), based on the total weigh to of the epoxy resin component. The epoxy resin component may further include other epoxy resins, such as other epoxy resins that are aliphatic, cycloaliphatic, aromatic, cyclic, heterocyclic, or include mixtures thereof. The epoxy resin component may include only epoxy resin, so as to include a total of 100 wt % of epoxy resins. In exemplary embodiments, the epoxy resin component consists essentially of a liquid epoxy resin and an epoxy novolac resin.

Exemplary epoxy novolac resins include epoxidized phenol novolac resins (such as epoxidized bisphenol A novolac) and phenol-aldehyde novolac resins (i.e., the reaction product of phenols and simple aldehydes such as formaldehyde), and substituted phenol-aldehyde novolac resins (such as halogenated phenol-aldehyde novolac resins). The epoxy novolac resin may be the reaction product of epihalohydrin and novolac resins, o-cresol novolacs, and/or phenol novolacs. Examples of epoxy novolac resins include D.E.N.™ series resins available from The Dow Chemical Company.

Exemplary liquid epoxy resins including reaction products of epichlorohydrin with polyfunctional alcohols, phenols, bisphenols, halogenated bisphenols, hydrogenated bisphenols, polyglycols, polyalkylene glycols, cycloaliphatics, carboxylic acids, aromatic amines, aminophenols, or combinations thereof. Examples of liquid epoxy resins include D.E.R.™ series resins available from The Dow Chemical Company. Exemplary liquid epoxy resins include such as D.E.R.™ 383 a diglycidylether of bisphenol A (DGEBA) having an epoxide equivalent weight (EEW) of from about 175 to about 185, a viscosity of about 9.5 Pa-s and a density of about 1.16 g/cc.

### Amine Hardener Component

The amine hardener component includes at least one aromatic amine and optionally at least one cycloaliphatic amine. The amine hardener component may be referred to as the curing agent or crosslinking agent. The amine hardener component may account for 5 wt % to 50 wt % (e.g., 5 wt % to 40 wt %, 10 wt % to 30 wt %, 15 wt % to 25 wt %, etc.) of the curable composition. For example, when the curable composition includes the epoxy resin component, the amine hardener component, and the accelerator component. The amine hardener component may further include other amine hardeners, such as arylaliphatic amines, aliphatic amines, heterocyclic amines, and/or polyetheramines. The amine hardener component may include only amine based hardeners, so as to include a total of 100 wt % of amine hardeners. In exemplary embodiments, the amine hardener component consists essentially of an aromatic amine or a combination of an aromatic amine and a cycloaliphatic amine.

The amine hardener component may include the at least one aromatic amine in an amount from 5 wt % to 100 wt % (e.g., 20 wt % to 100 wt %, 30 wt % to 100 wt %, 40 wt % to 100 wt %, 45 wt % to 100 wt %, 45 wt % to 60 wt %, etc.), based on the total weight of the amine hardener component. The amine hardener component may include the optional at least one cycloaliphatic amine in an amount from 0 wt % to 95 wt % (e.g., 1 wt % to 80 wt %, 5 wt % to 70 wt %, 15 wt % to 65 wt %, 30 wt % to 60 wt %, 40 wt % to 60 wt %, etc.), based on the total weight of the amine hardener component.

Exemplary aromatic amine hardeners include diethyltoluenediamine (DETDA); 4,4′-diaminodiphenyl ether; 3,3′-diaminodiphenyl sulfone; 1,2-, 1,3-, and 1,4-benzenediamine; bis(4-aminophenyl)methane; bis(4-aminophenyl)sulfone; 1,2-diamino-3,5-dimethyl benzene; 4,4′-diamino-3,3′-dimethylbiphenyl; 1,3-bis-(m-aminophenoxy)benzene; 9,9-bis(4-aminophenyl)fluorene,3,3′-diaminodiphenylsulfone; 4,4′-diaminodiphenylsulfide; 1,4-bis(p-aminophenoxy)benzene; 1,4-bis(p-aminophenoxy)benzene; 1,3-propanediol-bis(4-aminobenzoate); and mixtures thereof.

Exemplary cycloaliphatic amines include 2-methylcyclohexane-1,3-diamine (MDACH, such as Baxxodur® ECX 210 available from BASF SE); 1,3-bisaminocyclohexylamine (1,3-BAC); isophorone diamine (IPD); 4,4′-methylenebiscyclohexanamine; bis-(p-aminocyclohexyl) methane (PACM); 1,4-diaminocyclohexane; 1,2-diamino-4-ethylcyclohexane; 1,4-diamine-3,6-diethylcyclohexane; 1-cyclohexyl-3,4-diaminocyclohexane; 1,2-diaminocyclohexane; and mixtures thereof.

### Accelerator Component

As discussed in U.S. Provisional Application No. 62/082,180, an “accelerator” or “catalyst” for an epoxy resin composition is defined as a compound or mixtures of compounds that catalyzes the curing reaction of an epoxide with hardeners. Such an “accelerator” accelerates the reaction, and makes it possible for the curing reaction to be conducted at a lower temperature and/or for a shorter time as compared to compositions that do not contain such an accelerator. The accelerator composition is designed for increasing the reactivity of an epoxy resin and an aromatic amine hardener, which may result in more than 20% lower exotherm onset temperatures, as determined by DSC using a 10° C./min scan rate, or less than an hour of cure time at 150-160° C.

The accelerator component includes (i) at least one transition metal complex having a transition metal ion and an oxygen donor ligand, and (ii) at least one salt having a cation including a metal ion or an onium ion, and an anion including a non-nucleophilic anion. The accelerator component may optionally include a carrier solvent, such as a low molecular weight carrier polyol. The accelerator component is present in an amount greater than 0 and up to 15 wt %. For example, the accelerator component may account for 0.001 wt % to 15.000 wt % (e.g., 0.001 wt % to 5.000 wt %, 0.001 wt % to 1.000 wt %, 0.001 wt % to 0.100 wt %, etc.) of the curable composition. For example, when the curable composition includes the epoxy resin component, the amine hardener component, and the accelerator component. The accelerator component may further include other accelerators and/or catalysts. In exemplary embodiments, the amine hardener component consists essentially of (i) a transition metal complex having a transition metal ion and an oxygen donor ligand, and (ii) a salt having a cation including a metal ion or an onium ion, and an anion including a non-nucleophilic anion. The accelerator component may be pre-mixed with the amine hardener component to form a first mixture, the first mixture may then be added to the epoxy resin component. The first mixture may include from 1 wt % to 10 wt % of the accelerator component, based on the total weight of the first mixture.

The accelerator component may include from 5 wt % to 95 wt % (e.g., 5 wt % to 80 wt %, 5 wt % to 70 wt %, 5 wt % to 60 wt %, 5 wt % to 50 wt %, 10 wt % to 40 wt %, 15 wt % to 30 wt %, etc.) of the (i) at least one transition metal complex having a transition metal ion and an oxygen donor ligand, based on the total weight of the accelerator component. The accelerator component may include from 5 wt % to 95 wt % (e.g., 5 wt % to 80 wt %, 5 wt % to 70 wt %, 5 wt % to 60 wt %, 5 wt % to 50 wt %, 10 wt % to 40 wt %, 15 wt % to 30 wt %, etc.) of the (ii) at least one salt having a cation including a metal ion or an onium ion, and an anion including a non-nucleophilic anion. The accelerator component may include from 0 wt % to 90 wt % (e.g., 5 wt % to 90 wt %, 10 wt % to 80 wt %, 20 wt % to 80 wt %, 30 wt % to 70 wt %, 40 wt % to 70 wt %, 50 wt % to 70 wt %, 55 wt % to 65 wt %, etc.) of the carrier solvent, based on the total weight of the accelerator component.

For example, the accelerator component used to form the curable composition according to embodiments includes: the (i) transition metal complex, and (ii) the salt; wherein the transition metal complex, component (i), includes a transition metal ion and an oxygen donor ligand. The transition metal ion component can be chromium (III), Zn (II), molybdenum (III), or mixtures thereof. The oxygen donor ligand component, can be derived from a beta-diketone or a carboxylate ion derived from an organic acid such as octoate or 2-ethyl-hexanoate. When acetyl acetone loses a hydrogen ion, an anion forms called acetyl acetonate which is the ligand component of the transition metal complex. The donor ligand component of the transition metal complex may also be nitrogen donor ligands such as ethylene diamine, diethylene triamine or mixed nitrogen and oxygen donors such as triethanol amine, and the like.

The carboxylate ion derived from an organic acid may be a substituted or unsubstituted, a linear or branch-chained aralkyl or alkyl carboxylate containing C₂-C₂₀ carbon atoms; a substituted or unsubstituted aryl carboxylic acid; or mixtures thereof. For example, the at least one transition metal complex is chromium (III) octoate, chromium (III) 2-ethylhexanoate, chromium (III) acetate, chromium(III) heptanoate, formulated chromium (III) carboxylate complexes, zinc (II) octoate, zinc (II) acetyl, molybdenum (III) octoate, or mixtures thereof.

The salt, component (ii) of the accelerator composition, includes a cation, wherein the cation includes a metal ion or an onium ion; and an anion wherein the anion includes a non-nucleophilic anion. For example, the metal cation component of the salt may include a transition metal such as Cu, Co, Zn, Cr, Fe, Ni, or the like; and the onium ion component of the salt can be, e.g., an alkyl, aralkyl, or aryl ammonium ion; or an alkyl, aralkyl, or aryl phosphonium ion. The non-nucleophilic anion component of the salt can be, e.g., BF₄⁻, PF₆⁻, AsF₆⁻, SbF₆⁻, FeCl₄⁻, SnCl₆⁻, BiCl₅⁻, AlF₆, GaCl₄⁻, InF₄⁻, TiF₆⁻, ZrF₆⁻, or ClO₄⁻, or the like. Other suitable anions may include, for example, (CH₃)₂(C₆H₅)₂B⁻, (C₆H₅)₄B⁻, and (C₄H₇)₄B⁻. The salts useful in the embodiments may or may not contain crystalline water. Examples of the salt includes, Cu(BF₄)₂, Zn(BF₄)₂, Co(BF₄)₂, Fe(BF₄)₂, Ni(BF₄)₂, Mg(BF₄)₂, Cu(PF₆)₂, Zn(PF₆)₂, Co(PF₆)₂, Fe(PF₆)₂, Mg(PF₆)₂, Cu(ClO₄)₂, Zn(ClO₄)₂, Co(ClO₄)₂, Fe(ClO₄)₂, Ni(ClO₄)₂, Mg(ClO₄)₂, and mixtures thereof.

One of the beneficial properties of the accelerator component is to both provide latency and to speed up the reaction between epoxy resin and amine hardeners. The need may be the most acute in the case when the slowest curing amine, that is, an aromatic amine, is used with an epoxy composition. In particular, the reactivity of amines, may generally decrease in the following order: aliphatic, cycloaliphatic, and aromatic amines. As such, there is typically a need to speed up the curing reaction between an epoxy resin and an aromatic amine hardener. For example, due to the low reactivity between an epoxy resin and an aromatic amine hardener, a high cure temperature and long cure time are generally needed to manufacture a high performance crosslinked polymer material. However, increasing cure temperature and cure time, increases the processing cost and limits the application of aromatic amine hardeners in some important composite fabrication techniques, such as pultrusion, resin transfer molding (RTM), prepregging, compression molding, filament winding, and PRTM processes.

The carrier solvent may be referred to as solubilizing agent (such as solvent or diluents that are essentially inert to component (i) and (ii) at ambient or room temperature). Suitable such carrier solvents include, e.g., alcohols, esters, glycol ethers, ketones, aliphatic and aromatic hydrocarbons, polyalkylene glycols, polyalkylene glycol monoethers, combinations thereof, and the like. In exemplary embodiments, the carrier solvent and/or solubilizing agent may be an alcohol, a glycol, a glycol ether, a ketone, or mixtures thereof.

### Reinforcement Material

The curable composition may be used to form fiber-reinforced composite. The reinforcement material used to form the fiber-reinforced composite may include, e.g., a continuous fiber reinforcement such as one or more of carbon, glass, aramid (Kevlar®, Twaron®, and the like.), ceramic (e.g., silicon carbide, aluminum oxide, the like); and mixtures thereof. In an exemplary embodiment, the continuous fiber reinforcement useful in the process of the present invention may include for example, glass fibers or mats (e.g., E-glass, S-glass, and the like.), carbon fibers (e.g., polyacrylonitrile-based and pitch-based), aramid fibers, ceramic (e.g., silicon carbide, aluminum oxide, and the like), or mixtures thereof. One of the beneficial properties of the reinforcement material is that reinforcement materials may have a high tensile strength and modulus and may greatly improve the overall properties of a resultant composite article.

### Optional Components

An optional component that may be added to the curable composition includes one or more additives/compounds that are normally used in resin formulations and/or known to those skilled in the art for preparing such curable compositions. The optional component may be present in an amount from 0 wt % to 70 wt % (from 0 wt % to 40 wt %, 1 wt % to 10 wt %, 1 wt % to 5 wt %, etc.), based on the total weight of the curable composition.

For example, the optional component may comprise compounds that can be added to the composition to enhance application properties (e.g., surface tension modifiers or flow aids), reliability properties (e.g., adhesion promoters), the reaction rate, the selectivity of the reaction, and/or the catalyst lifetime. Other optional compounds that may be added to the curable composition include, e.g., other co-catalysts, de-molding agents, a solvent to lower the viscosity of the formulation further, other resins such as a phenolic resin that can be blended with the other ingredients in the curable composition, adduct curing agents, fillers, pigments, toughening agents, flow modifiers, adhesion modifiers, diluents, stabilizers, plasticizers, catalyst de-activators, flame retardants, and mixtures thereof.

### Curable Composition

The process for preparing the curable formulation includes admixing (A) the epoxy resin component; (B) the amine hardener component; (C) the accelerator component; and (D) optionally, any other optional ingredients as desired. Above components can be added to the mixture in any order. Each of the epoxy resin component, the amine hardener component, and the accelerator component (if includes one more than one compound) may be prepared in separate blending stages (e.g., in known mixing equipment) to form the components. The preparation of the curable composition may be achieved by pre-blending (e.g., in known mixing equipment) the accelerator component, amine hardener component, and optionally any other desirable additives. Further, by optionally separately blending (e.g., in known mixing equipment) the above-described epoxy resin component and any other desirable additives. Then, the pre-blended the accelerator component, amine hardener component, and optionally any other desirable additives component may be blended with the epoxy resin component (or the epoxy resin component blended with any other desirable additives).

The process for preparing the curable component includes admixing at least the components (A)-(C) described above. Then the mixture may be processed under predetermined conditions, such as at a predetermined temperature and time, to form an effective resin composition. The temperature of admixing may be in the range of from −10° C. to 150° C. (e.g., 0° C. to 80° C., 10° C. to 40° C., etc.) The process of for forming the resin composition may be a batch process, an intermittent process, or a continuous process using equipment known to those skilled in the art. The curable composition may be useable in a Stage 1 process where the components are mixed, and a Stage 2 process where the fiber-reinforcement material is provided (e.g., in the form of fiber roving, tows, continuous fibers or discontinuous fibers, or mixtures thereof) and impregnating with the curable composition by contacting the fiber reinforcement material with the curable composition. Further, a Stage 3 includes curing the impregnated fiber-reinforcement of Stage 2 to form a fiber-reinforced composite article.

### Pultrusion-Resin Transfer Molding Processes

A PRTM process is a combination process of a pultrusion (P) process and a resin transfer molding (RTM) process, and an exemplary PRTM process is discussed in U.S. Pat. No. 7,867,568. It is believed the PRTM process may be able to produce structural composite profiles at production speeds up to 30 cm/min. A pultrusion process is useful for producing a composite structure at a high production rate (e.g. 30-100 cm/min and/or 30 to 50 cm/min), but the pultrusion process, when used alone, is typically suitable for producing straight elongated parts with a uniform cross-section. A RTM process is useful for producing parts with complex geometries and curved parts with a de-mold time within a few minutes (e.g., less than 3 minutes). However, the types of parts that can be manufactured by a RTM process, when used alone, are limited by the equipment. For example, the viscosity of the resin used in the RTM process must be low enough to ensure that the resin is evenly distributed throughout the reinforcement package, which limits the mechanical properties that can be expected for the finished parts.

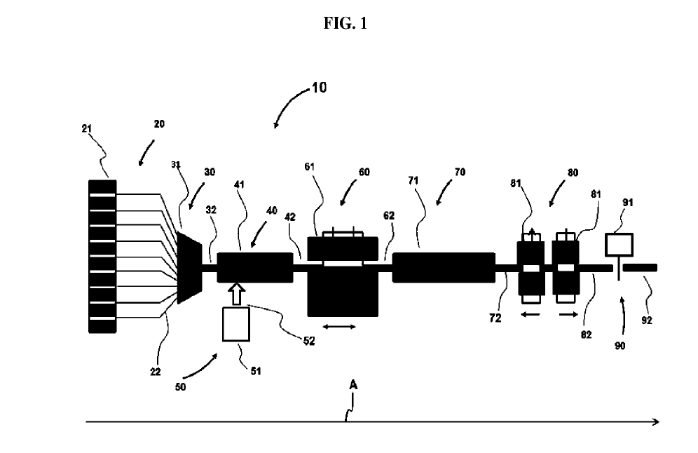

Referring to schematic flow diagram in FIG. 1, an exemplary PRTM process 10 includes a fiber roll region or creel 20 with a series of stored fiber rolls having thereon reinforcement fibers, a fiber guide region 30, an injection region 40, a resin injection source 50; a moving press region 60, a convection oven region 70, a puller region 80, and a cutting region 90.

The creel or fiber roll region 20 may include a plurality of stored fiber rolls 21 with reinforcement fibers 22 thereon. The fibers are adapted for feeding into the process flow through the fiber guide region 30. The fiber reinforcements 22 may be, e.g., glass fibers or mats, carbon fibers, aramid fibers, ceramic (e.g., silicon carbide, aluminum oxide, and the like), or combinations thereof. With respect to the fiber guide region 30, the reinforcement fibers 22 pass through a guide member 31, which gathers and aligns the fibers from all of the rolls into a number of fiber tows 32 that exit the guide member 31. The fiber tows 32 are then fed into the injection die 41 of the injection region 40.

The injection region 40 includes the injection die 41 that receives the fiber tows 32 and has fed therein a composition feed stream 52. The composition feed stream 52 is fed from a resin source vessel 51 to the injection die 41. According to exemplary embodiments, the resin source vessel 51 may have separate chambers for holding the epoxy resin component and a mixture of the amine hardener components and the accelerator components. For example, the resin source vessel 51 may allow for the two separate components to contact right before forming the composition feed stream 52. In other exemplary embodiments, the resin source vessel 51 may include the curable composition, which has been pre-mixed and feed into the resin source vessel 51. Within the injection die 41, the composition feed stream 52 and the fiber tows 32 contact each other for a sufficient amount of time such that the resin is allowed to impregnates the fibers. Then, resin impregnated fibers 42 exit the injection die 41 in a B-Stage physical state and are fed into the moving heated press region 60.

The moving heated press region 60 includes a moving press 61, whereas the resin impregnated fibers 42 are feed into the moving process. In the moving heated press region 60, pressure and heat are applied to the resin impregnated fibers 42 to give the final shape of composite parts and to advance the B-stage resin to a C-Stage or cured state. The temperature of moving heated press 61 may be within the range of 150-210° C.

Then, the pressed fibers 62 are fed into a convection oven region 70 having therein a convection oven 71. In the convection oven region 70, the fibers 62 are fed into the convection oven 71, which is heated to a high temperature (e.g., within the range 180 to 210° C.) sufficient to complete the curing process of the resin impregnated fibers 62. Then, the cured composite 72 exits the convection oven 71 and is fed into the puller region 80.

The puller region 80 includes a puller apparatus 81, which pulls the cured composite 72 in the direction indicated by the letter “A” in FIG. 1. Then, the pulled composite 82 exits the puller apparatus 81 and is fed into the cutter region 90. The cutter region 90 includes a cutting apparatus 91, where the pulled composite article 82 is cut into predetermined lengths to form a composite product 92. The composite product 92 then exits the cutting apparatus 91.

The following examples are provided to illustrate the invention, but are not intended to limit the scope thereof. All parts and percentages are by weight unless otherwise indicated. Unless stated otherwise, molecular weight is based on number average molecular weight. Unless stated otherwise, the accelerator concentrations refer to weight percentages in the hardener; and the epoxide amine equivalent ratios are approximately 1.

### Examples

Approximate properties, characters, parameters, etc., are provided below with respect to various working examples, comparative examples, and the materials used in the working and comparative examples.

### Analytical Methods

Differential scanning calorimetry (DSC) analysis is performed using a Q2000 model DSC from TA Instruments, which is equipped with an auto sampler and a refrigerated chiller system (RSC). Around 10 grams (g) of a formulated sample are mixed by using a FlackTek mixer (at 2,200 revolutions per minute [rpm] for 2 min). Then, 5-10 milligrams (mg) of the resulting sample are transferred to a hermetic aluminum pan (Hermetic aluminum pan is purchased from TA Instruments with part number: TA 900793-901/900794-901). The pan are sealed and placed in the auto-sample tray. A brief description of the method of the DSC analysis (a method known to those skilled in the art) is the following: (i) Stage 1—Equilibrate at 0° C., (ii) Stage 2—Ramp 5.00° C./min to 250° C., (iii) Stage 3—Mark end of cycle 1, (iv) Stage 4—Isotherm @ 250° C. for 10 min, (v) Stage 5—Equilibrate at 30.00° C., (vi) Stage 6—Mark end of cycle 2, (vii) Stage 7—Ramp 10.00° C./min to 250° C., and (viii) Stage 8—End of method.

Dynamic Mechanical Thermal Analysis (DMTA) analysis is performed to determine glass transition temperature (Tg), using a TA instrument Rheometer (Model: ARES). Rectangular samples (around 6.35 cm×1.27 cm×0.32 cm) are placed in solid state fixtures and subjected to an oscillating torsional load. The samples are thermally ramped from about 25° C. to about 300° C. at a rate of 3° C./min and 1 Hertz (Hz) frequency.

Mechanical Properties such as tensile and fracture toughness are determined using ASTM methods. In particular, tensile tests are performed using ASTM D-638 (type I) method. Fracture toughness (K1C) of materials is measured according to ASTM D-5045 by a screw-driven material testing machine (Instron model 5567). Compact-tension geometry is used.

### Accelerator Component

The following materials are principally used:

| | |
|---|---|
| Liquid Epoxy | A liquid epoxy resin that is the is a reaction |
| | product of epichlorohydrin and bisphenol A, |
| | having an epoxide equivalent weight from 173-183, |
| | and a viscosity at 25° C. from 9000-10500 mPa * s |
| | according to ASTM D-445 (for example, |
| | available from The Dow Chemical Company as |
| | D.E.R. ™ 383). |
| Novolac Epoxy | A novolac epoxy resin that is a semi-solid |
| | reaction product of epichlorohydrin and phenol- |
| | formaldehyde novolac, having an epoxide |
| | equivalent weight from 176-181, and a viscosity |
| | at 51.7° C. from 31,000-40,000 mPa * s according |
| | to ASTM D-445 (for example, available from The |
| | Dow Chemical Company as D.E.N. ™ 438). |
| Curative 1 | A composition including from 75-81 wt % of 3,5- |
| | diethyltoluene-2,4-diamine and from 18-20 wt % |
| | of 3,5-diethyltoluene-2,6-diamine (available as |
| | ETHACURE ® 100 from Albemarle). |
| Curative 2 | A mixture including 2-methylcyclohexane-1,3- |
| | diamine (for example, available as Baxxodur ® |
| | ECX 210 from BASF). |
| DACH | 1,2-Diaminocyclohexane (available as DYTEK ® |
| | DCH-99 from Invista). |
| Cu(BF₄)₂ | Copper (II) tetrafluoroborate hydrate (for |
| | example, commercially available from Strem |
| | Chemicals Inc). |
| Cr(octoate)₃ | Chromium (III) 2-ethylhexanoate (for example, |
| | commercially available from Alfa Aesar, The |
| | Shepherd Chemical Company, and Dimension |
| | Technology Chemical Systems). |
| Cr(acac)₃ | Chromium (III) acetylacetonate (for example, |
| | commercially available from Sigma-Aldrich). |
| Carrier Solvent | A polypropylene glycol having a molecular |
| | weight of 425 g/mol (available as Polygolycol P |
| | 425 from The Dow Chemical Company). |

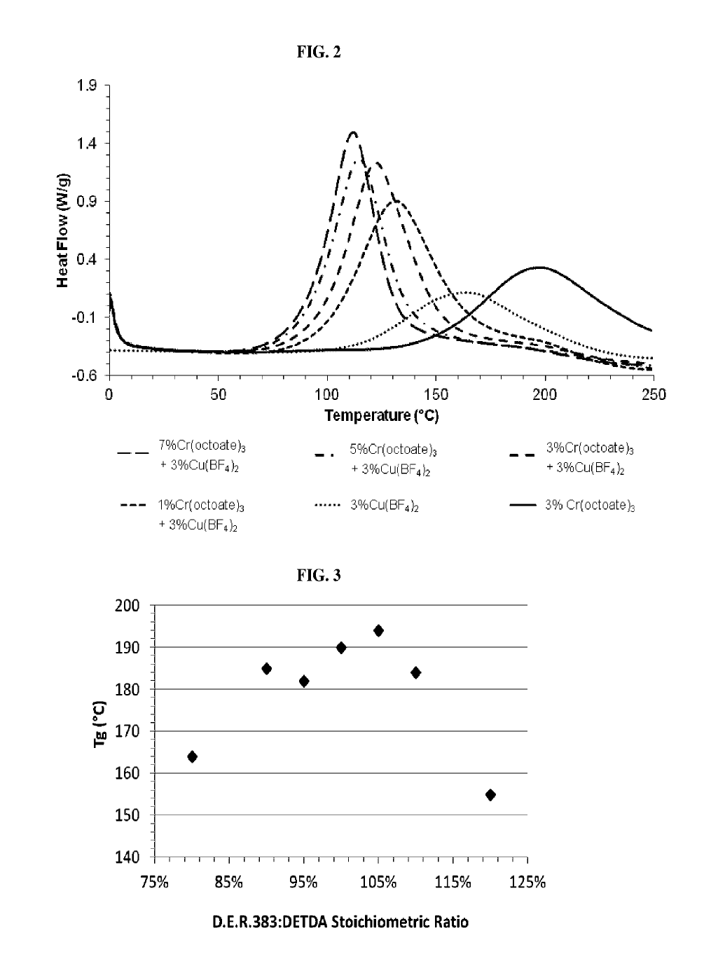

An accelerator component, according to embodiments, is prepared by combining Cu(BF₄)₂ with Cr(octoate)₃ at 70-80° C. under vigorously agitation for 2-3 hours in the carrier solvent. Various mixtures of Cu(BF₄)₂ and/or Cr(octoate)₃ are prepared to evaluate cure kinetics as related to the temperature versus heat flow profiles shown in FIG. 2, when an epoxy resin component (Part A) and an amine hardener component (Part B) are combined. In particular, as shown in FIG. 2, various formulations are evaluated and compared with respect to the use of no catalyst, the use of Cu(BF₄)₂ alone, the use of Cr(octoate)₃ alone, and the use of both Cu(BF₄)₂ and Cr(octoate)₃. Further, Part A includes 100 wt % (80.5 grams) of Liquid Epoxy. Part B includes 90-98 wt % (19.1 grams) of Curative 1, 0-3 wt % (0.2 grams) of Cu(BF₄)₂, and 0-7 wt % (0.2 grams) of Cr(octoate)₃. Parts A and B are mixed at a 1:1 stoichiometric ratio. Sharp exotherm peaks, indicate a fast-cure reaction. The observed reactivity of the various accelerator components are shown in Table 1, below.

TABLE 1

| | | Onset | Exotherm Peak | |
|---|---|---|---|---|
| Accelerator | Tg | Temperature | Temperature | Enthalpy |
| Component | (° C.) | (° C.) | (° C.) | (J/g) |
| 1% Cu(BF₄)₂ + 1% | 196 | 103 | 134 | 397 |
| Cr(octoate)₃ | | | | |
| 1% Cu(BF₄)₂ + 2% | 192 | 100 | 126 | 417 |
| Cr(octoate)₃ | | | | |
| 1% Cu(BF₄)₂ + 3% | 180 | 94 | 124 | 384 |
| Cr(octoate)₃ | | | | |
| 1% Cu(BF₄)₂ + 5% | 179 | 88 | 118 | 382 |
| Cr(octoate)₃ | | | | |
| 3% Cu(BF₄)₂ + 1% | 198 | 98 | 133 | 438 |
| Cr(octoate)₃ | | | | |
| 3% Cu(BF₄)₂ + 3% | 204 | 96 | 123 | 430 |
| Cr(octoate)₃ | | | | |
| 3% Cu(BF₄)₂ + 5% | 192 | 90 | 115 | 414 |
| Cr(octoate)₃ | | | | |
| 3% Cu(BF₄)₂ + 7% | 191 | 89 | 112 | 423 |
| Cr(octoate)₃ | | | | |
| 1% Cu(BF₄)₂ | 186 | 111 | 180 | 350 |
| 3% Cu(BF₄)₂ | 198 | 114 | 164 | 434 |
| 3% Cr(octoate)₃ | 156 | 148 | 194 | 216 |
| None | 175 | 144 | 187 | 373 |

*1% cu(BF₄)₂ + 1% Cr(octoate)₃ refers to a mixture of 1 wt % of Cu(BF₄)₂ and 1 wt % of Cr(octoate)₃ in 98 wt % Curative 1

Referring to Table 1 and FIG. 2, it is shown that reaction onset temperatures and exotherm peak temperatures are reduced compared to the control while still realizing a good enthalpy and high Tg (glass transition temperature). For example, when only 3 wt % of Cr(octoate)₃ is used an as accelerator, without the addition of Cu(BF₄)₂, the exotherm peak temperature is as high as 194° C. and Liquid Epoxy and Curative 1 may not be completely cured at 250° C., meaning that Cr(octoate)₃ by itself cannot sufficiently catalyze the reaction. In comparison, with the accelerator component according to embodiments, such as 3 wt % Cr(octoate)₃ and 1 wt % Cu(BF₄)₂, the onset temperature and the exotherm peak temperature can be substantially lowered, e.g., to be less than 105° C. and less than 135° C., respectively. The onset temperature, exotherm peak temperature, and enthalpy are measured using DSC. Onset temperature refers to the means the intersection of tangents of the exothermic peak with the extrapolated baseline.

To further investigate the latency and reactivity of epoxy resins with the accelerator components, the gel time with various accelerators is measured at 25° C. and 100° C., as shown in Table 2, below. For the examples, Part A includes 100 wt % of Liquid Epoxy. Part B includes 97-98 wt % of Curative 1, 0-2 wt % of Cu(BF₄)₂, and 1-3 wt % of Cr(octoate)₃. Parts A and B are mixed at a 1:1 stoichiometric ratio.

TABLE 2

| | | Gel | |
|---|---|---|---|
| | Gel Time @ | Time @ | Gel Time @ |
| | 25° C. | 100° C. | 150° C. |
| Accelerator Component | (hours) | (minutes) | (seconds) |
| 1% Cu(BF₄)₂ + 1% Cr(octoate)₃ | 49.8 | 18 | 198 |
| 1% Cu(BF₄)₂ + 2% Cr(octoate)₃ | 39.8 | 6 | 59 |
| 3% Cr(octoate)₃ | 10.5 | 54 | 431 |
| None | 107.1 | 195 | 1670 |

Referring to Table 2, epoxy resin/Curative 1 without accelerator shows long gel time at 25° C. and elevated temperature (100° C. and 150° C.), demonstrating the slow reactivity between epoxy resin and Curative 1 without accelerator. Whereas, epoxy resin/Curative 1 with Cu(BF₄)₂ and Cr(octoate)₃ accelerator shows a significant reduction in gel time at higher temperatures (such as 100° C. and 150° C.), indicating a remarkable increase in reactivity. Furthermore, the long gel time at 25° C. (>30 hrs) for catalyzed resin system indicates the system has a good latency and pot life. Gel time as used herein, with reference to curing a composition, means the mixture is incapable of flow and in molecular terms gel time refers to the point at which an infinite network is formed. The gel time of epoxy-resin composition is determined by Gardner Standard Model Gel Timers (gel time of mixture at 25° C.) and Gelnorm Gel Timer (gel time of mixture at 80° C. and 100° C.). A gel time at 25° C. that is over 30 hours, indicates the system has a good latency and pot life.

Referring to FIG. 3, the effect of epoxy-amine stoichiometry on Tg, when using the accelerator component according to embodiments, is observed. In particular, homo-polymerization of an epoxy may result in a drop of Tg and mechanical properties. To determine whether the accelerated reaction is due to the acceleration of homo-polymerization of an epoxy, analysis is performed using 1 wt % Cu(BF₄)₂ and 1 wt % Cr(octoate)₃ as the accelerator component. In particular, Tg is measured at various stoichiometric ratios of Part A (100 wt % of Liquid Epoxy) to Part B (98 wt % Curative 1, 1 wt % Cu(BF₄)₂, and 1 wt % Cr(octoate)₃). The stoichiometric ratio in FIG. 3 is presented as a percentage, and as would be understood by a person of ordinary skill in the art, 100% represents a 1:1 ratio of epoxy groups to amine reactive groups. If an accelerator component only catalyzes homo-polymerization of an epoxy, the Tg of the cured composition will not be affected by the stoichiometric ratio. However, as shown in FIG. 3, the Tg of the cured composition is affected by the stoichiometric ratio.

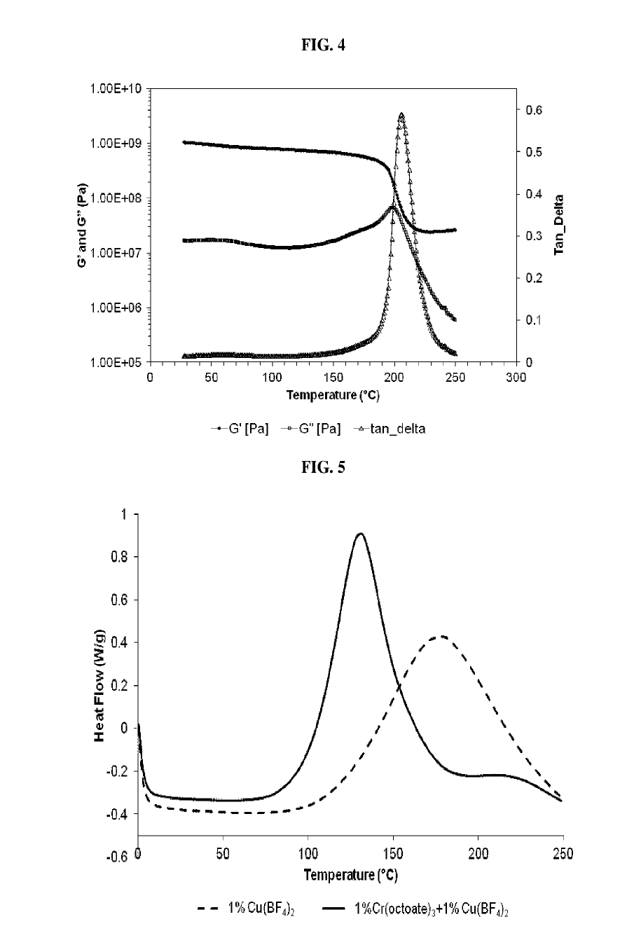

Referring to FIG. 4, the mechanical characterization of clear casts using the accelerator component according to embodiments is observed. In particular, FIG. 4 illustrates the DMTA analysis of a system that includes Part A (100 wt % of Liquid Epoxy) and Part B (98 wt % of Curative 1, 1 wt % Cu(BF₄)₂, and 1 wt % Cr(octoate)₃). Further, referring to FIG. 5, the exotherm peak is measured by DSC and compared to an exotherm peak when the 1 wt % Cr(octoate)₃ is excluded from Part B. As shown in FIG. 5, the exotherm peak is significantly higher and at a lower temperature, when both 1 wt % Cu(BF₄)₂, and 1 wt % Cr(octoate)₃ are included in Part B as the accelerator component. In addition, mechanical properties of the cured composition are tested by making clear casting plaques. The curing conditions include curing the resin at 100° C. for 1 hour and 180° C. for 1 hour. The mechanical property results are shown in Table 3, below.

TABLE 3

| | Tensile | Tensile | Fracture | |
|---|---|---|---|---|
| | Strength | Modulus | Toughness | Tg |
| Accelerator Component | (MPa) | (GPa) | (MPa · m^{1/2}) | (° C.) |
| 1% Cu(BF₄)₂ + | 68.5 | 2.61 | 0.45 | 202 |
| 1% Cr(octoate)₃ | | | | |

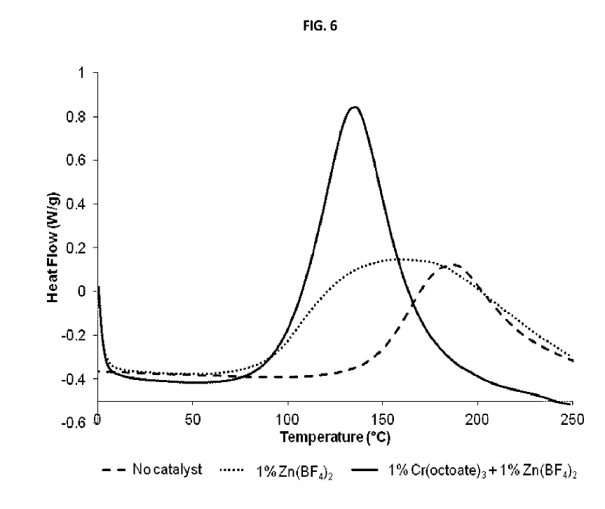

Referring to FIG. 6, a different accelerator component is synthesized by combining Zn(BF₄)₂ and Cr(octoate)₃. The accelerator component is synthesized using the following general procedure and using the amounts and compounds for the formulations described below. In particular, zinc (II) tetrafluoroborate (Zn(BF₄)₂) hydrate and diethylene glycol are obtained from Sigma-Aldrich. The Zn(BF₄)₂ is combined with Cr(octoate)₃ and diethylene glycol at 25 C under vigorously agitation for 2 min. The weight percentage of Zn(BF₄)₂, Cr(octoate)₃, and diethylene glycol in the accelerator system is 40%, 40% and 20%, respectively, whereas diethylene glycol is the carrier solvent. As shown in FIG. 6, the exotherm peaks of Part A (100 wt % Liquid Epoxy) and Part B (98-100 wt % Curative 1, 0-1 wt % Zn(BF₄)₂, and 0-1 wt % Cr(octoate)₃ are measured by DSC. When the accelerator component includes 1 wt % Zn(BF₄)₂ and 1% Cr(octoate)₃, as compared to when the accelerator component is excluded (i.e., No catalyst) and when % Cr(octoate)₃ is excluded (i.e., only 1 wt % Zn(BF₄)₂ is used), the speed of an epoxy-aromatic amine reaction can be significantly increased.

### Preparation of Curable Composition

The use of the accelerator component according to embodiments in a curable composition is analyzed as shown below. In particular, Working Examples 1 to 3 and Comparative Examples A to C are prepared according to the formulations shown below in Table 4.

For Working Examples 1 to 3, the accelerator component is prepared first, according to the overall amounts shown in Table 4. To prepare the accelerator component for use in the examples, 20 g of Cu(BF₄)₂, 20 g of Cr(octoate)₃, and 60 g of Polyglycol P425 (total 100 g) are weighted in a FlackTek cup, heated at 60-70° C. for 30 minutes, and mixed with FlackTek SpeedMixer at 2,000 rpm for 2 minutes. A homogeneous deep green solution may be obtained.

The Epoxy Resin Component, as referred to as Part A, is prepared by adding the components to a 5 gallon empty can, and then mixed at 60° C. for a period of 12 hours. The Amine Hardener Component is prepared by adding the components therein and the Accelerator Component to a flask to form the Part B, and then mixed at room temperature (˜23° C.) for a period of 3 hours. To prepare the curable composition, Part A and Part B are weighed in a FlackTek cup and mixed by FlackTek SpeedMixer at 2,200 rpm for 2 minutes.

TABLE 4

| | | | | | |
|---|---|---|---|---|---|
| Working | Working | Working | Comparative | Comparative | Comparative |
| Example 1 | Example 2 | Example 3 | Example A | Example B | Example C |

Epoxy Resin Component (parts by weight)

| | | | | | | |
|---|---|---|---|---|---|---|
| Liquid Epoxy | 20.0 | 20.0 | 20.0 | 20.0 | 100 | 20.0 |
| Novolac Epoxy | 80.0 | 80.0 | 80.0 | 80.0 | — | 80.0 |

Amine Hardener Component (parts by weight)

| | | | | | | |
|---|---|---|---|---|---|---|
| Curative 1 | 10.1 | 9.2 | 24.8 | — | 24.7 | 10.62 |
| Curative 2 | 10.7 | — | — | 17.8 | — | 10.08 |
| DACH | — | 9.7 | — | — | — | — |

Accelerator Component (parts by weight)

| | | | | | | |
|---|---|---|---|---|---|---|
| Cu(BF₄)₂ | 0.1 | 0.1 | 0.3 | — | 0.8 | — |
| Cr(octoate)₃ | 0.1 | 0.1 | 0.3 | — | — | — |
| Carrier Polyol | 0.3 | 0.3 | 0.9 | — | — | — |

Total Weight

| | | | | | | |
|---|---|---|---|---|---|---|
| Total (g) | 121.3 | 119.4 | 126.3 | 117.8 | 125.5 | 120.7 |

Viscosity of Resin System (mPa*s)

| | | | | | | |
|---|---|---|---|---|---|---|
| Viscosity of | 25,300 | 25,300 | 25,300 | 25,300 | 9,750 | 25,300 |
| Epoxy Resin | | | | | | |
| Component at | | | | | | |
| 25° C. | | | | | | |
| Viscosity | 34 | 30 | 190 | 7 | 310 | 29 |
| of Amine | | | | | | |
| Hardener | | | | | | |
| Component at | | | | | | |
| 25° C. | | | | | | |
| Viscosity of | 4,440 | 4,775 | 9,090 | 1,700 | 7,800 | 4,050 |
| Mixture at 25° C. | | | | | | |

Reactivity of Resin System

| | | | | | | |
|---|---|---|---|---|---|---|
| Gel time at 25° C. | 3.6 | 2.9 | 36.1 | 3.6 | 10.5 | 4.1 |
| (hours) | | | | | | |
| Gel time at | 188 | 234 | 25 | 115 | 431 | 307 |
| 150° C. (seconds) | | | | | | |

Properties of Resin System

| | | | | | | |
|---|---|---|---|---|---|---|
| Tensile strength | 75 | 72 | 61 | 78 | 68 | N/A |
| (MPa) | | | | | | |
| Tensile modulus | 3063 | 2840 | 2678 | 2950 | 2610 | N/A |
| (MPa) | | | | | | |
| Percent | 4.1 | 3.8 | 3.6 | 4.6 | 4.6 | N/A |
| Elongation at | | | | | | |
| break (%) | | | | | | |
| Tg (° C.) | 180 | 190 | 206 | 185 | 202 | N/A |

Referring to Table 4, it is seen that for Working Examples 1 to 3, a sufficiently high enough mixture viscosity at 25° C. is realized when the Accelerator Component is used. Further, referring to Working Examples 1 to 3, when the Accelerator Component combined with the Curative 2 are used, as compared to Comparative Example A that does not include the Accelerator Component and the Curative 2, the mixture viscosity at 25° C. is too low. Also, it is seen that for Working Examples 1 to 3, the use of both the Liquid Epoxy and the Novolac Epoxy, with the Accelerator Component, results in improved gel time at 150° C. (which is also an indicator of improved reactive), as compared to Comparative Example B and C that does not include the Accelerator Component.

The curable composition of Working Examples 1 to 3, as discussed above, are usable in a pultrusion-resin transfer molding (PRTM) process for composite structure fabrication. In an exemplary procedure for use of the PRTM process, a composite article is manufactured using the curable composition and the process discussed below. For example, Working Examples 1 to 3, provide higher high performance, such as a high glass transition temperature (greater than 140° C.) and/or good mechanical properties (such as a tensile strength greater than 60 MPa, a tensile modulus greater than 2500 MPa, and/or a percent elongation at break of greater than 3.5%).

The PRTM process begins with spools of fiber reinforcements coming from a creel. The fibers reinforcements are fed through various guides to uniformly feed the textile package into an injection die. The textile package is then pulled through a resin injection die, whereas Part A and Part B of the curable composition are mixed together and injected into the textile package. The resin impregnates the pulled textile package. As the resin impregnated textile package is pulled through the heated portion of the injection die, the resin composition is advanced to a B-stage. The B-stage composite is then drawn through a moving heated press where it is heated, pressed into a desired configuration, and further advanced to a C-stage (as would be understood by a person of ordinary skill in the art, the configuration is dependent on at least the size and shape of the desired composite article). From the press, the C-stage composite article is compounded, drawn through an oven where the curing process is completed. The cured composite is pulled with a puller apparatus and then in a final step the cured composite is cut to length.

An PRTM Process trial is ran using Working Example 1, according to the following conditions:

Textiles: Stitched multi-axial fiber reinforcements or textiles are used for the PRTM process.

Temperature Settings for the PRTM Machine are as follows:

Part A Reservoir: 25-60° C.; Part B Reservoir: 25-60° C.; and A/B Combined: 25-60° C.—at the mix head.
Die Entrance—25-60° C. (upstream of the injection point); Injection Point—61-100° C.; and Die temperature (downstream of the injection point)—110-180° C.

### Press Temperature—180-210° C. and Oven Temperature—200-210° C.

Working Example 1 is found to perform well in the PRTM process. For example, Working Example 1 can meet the operation condition profile of the PRTM process, which is outlined below in Table 5.

TABLE 5

| | Specification | |
|---|---|---|
| | Requirements | |
| Pultrusion line speed | 30 | cm/min |
| Mixing viscosity at 25° C. | >4000 | mPa * s |
| Viscosity at injection | 10-500 | mPa * s |

1. A curable composition, comprising:
an epoxy resin component that includes at least one multifunctional epoxy novolac resin and at least one multifunctional liquid epoxy resin;
an amine hardener component that includes at least one aromatic amine and optionally at least one cycloaliphatic amine; and
an accelerator component that includes (i) at least one transition metal complex having a transition metal ion and an oxygen donor ligand, and (ii) at least one salt having a cation including a metal ion or an onium ion, and an anion including a non-nucleophilic anion.

2. The composition as claimed in claim 1, wherein:
the epoxy resin component is present in an amount from 55 wt % to 95 wt %, based on the total weight of the curable composition,
the amine hardener component is present in an amount from 5 wt % to 50 wt %, based on the total weight of the curable composition, and
the accelerator component is present in an amount greater than 0 and up to 15 wt %, based on the total weight of the curable composition.

3. The composition as claimed in claim 1, wherein the epoxy resin component includes from 5 wt % to 95 wt % of the at least one multifunctional epoxy novolac resin and from 5 wt % to 95 wt % of the at least one multifunctional liquid epoxy resin, based on the total weight of the epoxy resin component.

4. The composition as claimed in claim 1, wherein:
the transition metal ion is chromium (III), Zn (II), molybdenum (III), or mixtures thereof, and
the oxygen donor ligand, component (b) is derived from a beta-diketone or a carboxylate ion derived from an organic acid, the carboxylate ion being derived from an organic acid being a substituted or unsubstituted, a linear or branch-chained aralkyl or alkyl carboxylate containing C₂-C₂₀ carbon atoms; a substituted or unsubstituted aryl carboxylic acid; or mixtures thereof.

5. The composition as claimed in claim 1, wherein the at least one transition metal complex is chromium (III) octoate, chromium (III) 2-ethylhexanoate, chromium (III) acetate, chromium(III) heptanoate, formulated chromium (III) carboxylate complexes, zinc (II) octoate, zinc (II) acetyl, molybdenum (III) octoate, or mixtures thereof.

6. The composition as claimed in claim 1, wherein the cation of the salt is the metal ion, and a metal of the metal ion is lithium, sodium, magnesium, calcium, aluminum, iron, cobalt, nickel, copper, zinc, tin, antimony, cadmium, lead, bismuth, or mixtures thereof.

7. The composition as claimed in claim 1, wherein the cation of the salt is the onium cation, and the onium ion is an alkyl, an aralkyl, or an aryl ammonium ion; an alkyl, an aralkyl, or an aryl phosphonium ion; or mixtures thereof.

8. The composition as claimed in claim 1, wherein the non-nucleophilic anion of the salt, is BF₄⁻, PF₆⁻, AsF₆⁻, SbF₆⁻, FeCl₄⁻, SnCl₆⁻, BiCl₅⁻, AlF₆⁻, GaCl₄⁻, InF₄⁻, TiF₆⁻, ZrF₆⁻, ClO₄⁻, or mixtures thereof.

9. The composition as claimed in claim 1, wherein the accelerator component further includes further a solubilizing agent, the solubilizing agent being an alcohol, a glycol, a glycol ether, a ketone, or mixtures thereof.

10. A composition for use in a pultrusion-resin transfer molding process, the composition comprising the curable composition as claimed in claim 1 and the composition having a viscosity at room temperature of higher than 4,000 mPa*s, having a fast gel time of less than 30 minutes at cure temperatures from 40° C. to 160° C., and having may have a gel time at room temperature of at least 30 minutes.

11. A pultrusion-resin transfer molding process, comprising the stage of providing the curable composition as claimed in claim 1 to an injection die.
